(19) United States
(12) Patent Application Publication
(10) Pub. No.: US 2021/0272498 A1
(43) Pub. Date: Sep. 2, 2021

(54) DISPLAY SUBSTRATE, DISPLAY PANEL AND DISPLAY DEVICE

(71) Applicants: Beijing BOE Display Technology Co., Ltd., Beijing (CN); BOE TECHNOLOGY GROUP CO., LTD., Beijing (CN)

(72) Inventors: Bo FENG, Beijing (CN); Shijun WANG, Beijing (CN)

(21) Appl. No.: 17/255,909

(22) PCT Filed: Jun. 19, 2020
(86) PCT No.: PCT/CN2020/097070

§ 371 Date: Dec. 23, 2020

(30) Foreign Application Priority Data
Jun. 26, 2019 (CN) 201910562628.3

(51) Int. Cl. G09G 3/20

(52) U.S. Cl. CPC G09G 3/2003; G09G 2310/0254; G09G 2300/0452

(57) ABSTRACT

A display substrate and a method of manufacturing the same, a display panel and a display device are provided. The display substrate includes multiple gate lines and multiple data lines a plurality of pixel regions are defined by the gate lines and the data lines, and arranged in a matrix each pixel region has two sub-pixels arranged in a first direction, two of the gate lines are arranged between every two adjacent rows of pixel regions, one column of pixel regions is arranged between every two adjacent data lines, the two sub-pixels in each pixel region are respectively coupled to one of the two adjacent data lines, polarities of voltages of the two adjacent data lines are opposite.

### CROSS-REFERENCE TO RELATED APPLICATION

This application claims priority to Chinese Patent Application No. 201910562628.3, filed on Jun. 26, 2019, the contents of which are incorporated herein by reference in the entirety.

### TECHNICAL FIELD

The present disclosure relates to the field of display technology, and more specifically, to a display substrate, a display panel and a display device.

### BACKGROUND

Recently, full screens have become focus of mobile phone manufacturers. The size of the left and right frames of a screen can be reduced by using low-resistance materials and high-mobility semiconductors, and the size of the lower frame can be reduced by using a dual gate structure.

### SUMMARY

In one aspect, the present disclosure provides a display substrate including: a plurality of gate lines in parallel with each other in a first direction and a plurality of data lines in parallel with each other in a second direction, the first direction and the second direction intersect each other, where a plurality of pixel regions are defined by the plurality of gate lines and the plurality of data lines, and arranged in a form of a matrix with multiple rows in the first direction and multiple columns in the second direction, each of the plurality of pixel regions has two sub-pixels arranged in the first direction, where two of the plurality of gate lines are arranged between every two adjacent rows of the plurality of pixel regions, one column of pixel regions is arranged between every two adjacent data lines of the plurality of data lines, the two sub-pixels in each pixel region are respectively coupled to one of the two adjacent data lines, and polarities of voltages of the two adjacent data lines are opposite, the two sub-pixels in each pixel region are two of a first sub-pixel, a second sub-pixel and a third sub-pixel, and in the pixel regions located in a same row, the polarities of the voltages of the data lines to which any two closest first sub-pixels are coupled are opposite, and the polarities of the voltages of the data lines to which any two closet second sub-pixels are coupled are opposite.

In some implementations, in the pixel regions located in a same row, the polarities of the voltages of the data lines to which any two closest third sub-pixels of a portion of the third sub-pixels are coupled are identical, and the polarities of the voltages of the data lines to which any closest third sub-pixels of the remaining third sub-pixels are coupled are opposite.

In some implementations, in the pixel regions located in a same row, the polarities of the voltages of the data lines to which any two closest third sub-pixels of the third sub-pixels are coupled are identical.

In some implementations, in the pixel regions located in a same row, the polarities of the voltages of the data lines to which any two closest third sub-pixels of the third sub-pixels are coupled are opposite.

In some implementations, the sub-pixels includes a red sub-pixel, a green sub-pixel and a blue sub-pixel.

In some implementations, the first sub-pixel is one of the red sub-pixel and the green sub-pixel, the second sub-pixel is the other of the red sub-pixel and the green sub-pixel, and the third sub-pixel is the blue sub-pixel.

In some implementations, in the pixel regions located in the same row, the sub-pixels are periodically arranged in a sequence of the red sub-pixel, the blue sub-pixel, the green sub-pixel, the red sub-pixel, the green sub-pixel, the blue sub-pixel, the green sub-pixel, the blue sub-pixel, the red sub-pixel, the green sub-pixel, the red sub-pixel and the blue sub-pixel.

In some implementations, in the pixel regions located in a same row, the sub-pixels are periodically arranged in a sequence of the green sub-pixel, the blue sub-pixel, the red sub-pixel, the green sub-pixel, the red sub-pixel, the blue sub-pixel, the red sub-pixel, the blue sub-pixel, the green sub-pixel, the red sub-pixel, the green sub-pixel and the blue sub-pixel.

In some implementations, the sub-pixels located in a same column are sub-pixels of a same color.

In another aspect, the present disclosure provides a method of manufacturing the display substrate described herein, including: forming a plurality of gate lines in parallel with each other in a first direction on a base substrate; forming a plurality of gate lines in parallel with each other in a second direction on the base substrate, where the first direction and the second direction intersect each other, the plurality of gate lines and the plurality of data lines are formed to define a plurality of pixel regions, the plurality of pixel regions are arranged in a form of a matrix with multiple rows in the first direction and multiple columns in the second direction, and forming two sub-pixels arranged in the first direction in each of the plurality of pixel regions, where two of the plurality of gate lines are arranged between every two adjacent rows of pixel regions, one column of pixel regions is arranged between every two adjacent data lines of the plurality of data lines, the two sub-pixels in each pixel region are respectively coupled to one of the two adjacent data lines, and polarities of voltages of the two adjacent data lines are opposite, the two sub-pixels in each pixel region are two of a first sub-pixel, a second sub-pixel and a third sub-pixel, and in the pixel regions located in a same row, the polarities of the voltages of the data lines to which any two closest first sub-pixels are coupled are opposite, and the polarities of the voltages of the data lines to which any two closet second sub-pixels are coupled are opposite.

In some implementations, the first sub-pixel is one of a red sub-pixel and a green sub-pixel, the second sub-pixel is the other of the red sub-pixel and the green sub-pixel, and the third sub-pixel is a blue sub-pixel.

In another aspect, the present disclosure provides a display panel, including: the display substrate described herein or manufactured according to the method described herein; and an opposite substrate aligned and assembled with the display substrate to form a cell.

In some implementations, the display substrate is an array substrate, and the opposite substrate is a color filter substrate.

In some implementations, the color filter substrate includes a plurality of color resist regions, and the plurality of color resist regions are arranged in a one-to-one correspondence with the plurality of sub-pixels of the display substrate.

In another aspect, the present disclosure provides a display device including the display panel described herein.

### BRIEF DESCRIPTION OF THE FIGURES

The following drawings are only examples for illustrative purposes according to various embodiments disclosed, and are not intended to limit the scope of the present invention.

FIG. 1 is a schematic top view of an arrangement of a display substrate with a dual gate structure according to the related art.

FIG. 2 is a schematic op view of an t arrangement of a display substrate according to an embodiment of the present disclosure.

FIG. 3 is a schematic top view of an arrangement of a display substrate according to another embodiment of the present disclosure.

FIG. 4 is a flowchart of a method of manufacturing a display substrate according to an embodiment of the present disclosure.

FIG. 5 is a schematic diagram of a cross-sectional structure of a display panel according to an embodiment of the present disclosure.

### DETAILED DESCRIPTION

To make those skilled in the art better understand the technical solutions of the present disclosure, the present disclosure will be further described in detail below in conjunction with the accompanying drawings and embodiments. It should be noted that the following description of some embodiments has been presented for purposes of illustration and description. It is not intended to be exhaustive or to limit to the precise forms disclosed, and the repeated description is omitted in order to avoid redundancy.

In order to keep the following description of the embodiments of the present disclosure clear and concise, detailed descriptions of known functions and known components may be omitted. When any one component of an embodiment of the present disclosure appears in more than one drawing, the component is represented by a same reference numeral in each drawing. Unless otherwise indicated, those skilled in the art can implement based on common technologies or conditions in the art or based on product instructions in a case that specific technologies or conditions are not clearly described in the following embodiments.

The present disclosure provides, inter alia, a display substrate, a display panel and a display device that substantially obviate one or more of the problems due to limitations and disadvantages of the related art. In the present disclosure, by means of designing the arrangement of sub-pixels, in the pixel regions located in a same row, polarities of voltages of any two closest first sub-pixels are opposite, polarities of voltages of any two closest second sub-pixels are opposite, and thus it is capable of effectively solving a problem of difference in pixel brightness due to a difference in positive and negative voltages of two adjacent data lines of a dual gate structure, thereby effectively solving a problem of shake lines of the dual gate structure.

FIG. 1 is a schematic top view of an arrangement of a display substrate with a dual gate structure according to the related art. As shown in FIG. 1, in some implementations, the display substrate with the dual gate structure includes a plurality of gate lines 101 arranged in parallel in a row direction (i.e., a first direction) and a plurality of data lines 102 arranged in parallel in a column direction (i.e., a second direction), the plurality of gate lines 101 and the plurality of data lines 102 are arranged crosswise and define a plurality of pixel regions, the plurality of pixel regions are arranged in the form of a matrix with multiple rows in the first direction and multiple columns in the second direction, and each pixel region has two sub-pixels arranged in the row direction. Two gate lines of the plurality of gate lines 101 are arranged between two adjacent rows of pixel regions. A column of pixel regions is arranged between two adjacent data lines 102, two sub-pixels in each pixel region are respectively coupled to one of the two adjacent data lines 102, and the polarities of the voltages of the two adjacent data lines 102 are opposite. The two sub-pixels between the two adjacent data lines 102 may be two of a first sub-pixel, a second sub-pixel and a third sub-pixel.

In this embodiment, the first to third sub-pixels may emit red light (R), green light (G) and blue light (B) respectively, and the sub-pixels in a same row may be periodically arranged in a sequence of the first sub-pixel, the second sub-pixel and the third sub-pixel. In addition, each of the sub-pixels located in a same column emits light of a same color, that is, each of the sub-pixels located in the same column is one of the first sub-pixel, the second sub-pixel and the third sub-pixel.

The reason why the above-mentioned thin film transistor liquid crystal display (TFT-LCD) design is prone to generation of shake lines is that spatially, in each row of pixel regions, the polarities of the voltages of all the first sub-pixels are set to a cyclic arrangement of “+−−+(positive, negative, negative, positive)”, the polarities of the voltages of all the second sub-pixels are set to a cyclic arrangement of “++−− (positive, positive, negative, negative)”, and the polarities of the voltages of all the third sub-pixels are set to a cyclic arrangement of “−++− (negative, positive, positive, negative)”, so that for a same type of sub-pixels (e.g., the first sub-pixel) in each row of pixel regions, a probability that the polarities of the voltages of any two adjacent sub-pixels (i.e., any two closest sub-pixels by distance) are identical is approximately equal to 50%. That is, it is difficult to average the polarities of the voltages of the same type of sub-pixels in a same frame of image on a spatial scale without significantly increasing power consumption, and thus streakiness caused by pixel brightness differences easily occur during a display process. In the related art, by averaging the polarities of the voltages of the same type of sub-pixels on a time scale, it is possible to make the display of the same type of sub-pixels more uniform within a time period. However, in this case, when a user moves his head during viewing, several frames of images may be missed, resulting in a worsening of averaging effect of the polarities of the voltages on the time scale and a phenomenon of shake lines. Therefore, the present disclosure provides a pixel arrangement method that ensures the polarities of the voltages of any two adjacent first sub-pixels (e.g., the red sub-pixel) to be opposite and the polarities of the voltages of any two adjacent second sub-pixels (e.g., the green sub-pixel) to be opposite, thereby effectively improving the display effect of the dual gate structure.

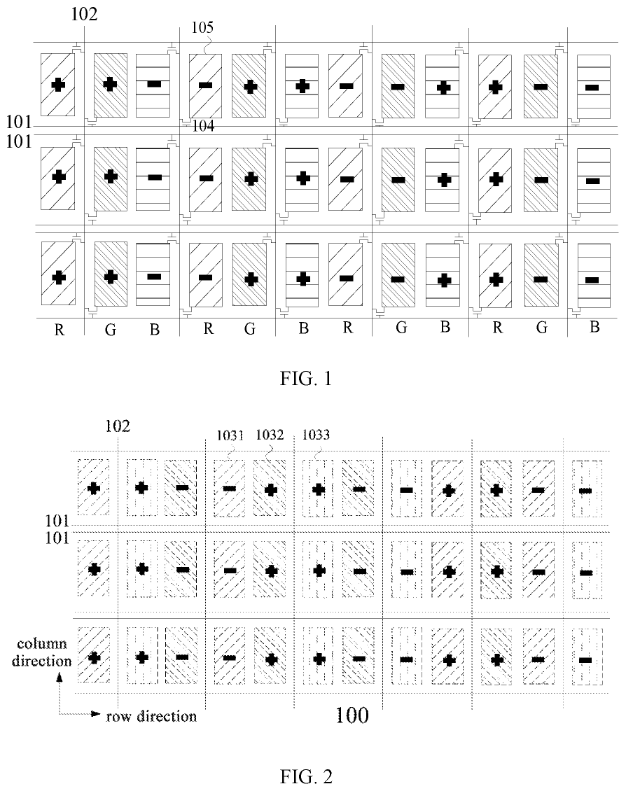

FIG. 2 is a schematic top view of an arrangement of a display substrate according to an embodiment of the present disclosure. As shown in FIG. 2, in some implementations, the display substrate 100 includes a plurality of gate lines 101 arranged in parallel in the row direction (i.e., the first direction) and a plurality of data lines 102 arranged in parallel in the column direction (i.e., the second direction), the row direction and the column direction intersect each other, the plurality of gate lines 101 and the plurality of data lines 102 define a plurality of pixel regions, and the plurality of pixel regions are arranged in the form of a matrix with multiple rows in the first direction and multiple columns in the second direction, each pixel region of the plurality of pixel regions has two sub-pixels (e.g., the first sub-pixel 1031 and the second sub-pixel 1032) arranged in the row direction. Two gate lines of the plurality of gate lines 101 are arranged between two adjacent rows of pixel regions, a column of pixel regions is arranged between two adjacent data lines 102, and two sub-pixels in each pixel region are respectively coupled to one of the two adjacent data lines 102, the polarities of the voltages of the two adjacent data lines 102 are opposite, and the two sub-pixels in each pixel region may be two of the first sub-pixel 1031, the second sub-pixel 1032 and the third sub-pixel 1033.

In this embodiment, the first to third sub-pixels 1031, 1032, and 1033 may emit red light (R), green light (G), and blue light (B) respectively, and the sub-pixels in a same row may be periodically arranged in a sequence of the first sub-pixel 1031, the second sub-pixel 1032 and the third sub-pixel 1033. In addition, each of the sub-pixels located in a same column emits light of a same color, that is, each of the sub-pixels located in the same column emits light of a same color, that is, each of the sub-pixels located in a same column is one of the first sub-pixel 1031, the second sub-pixel 1032 and the third sub-pixel 1033.

In the pixel regions of a same row, the polarities of the voltages (i.e., the polarity of the voltage of the coupled data line) of any two first sub-pixels 1031 (e.g., the red sub-pixel or the green sub-pixel) adjacent to each other (i.e., closest by distance) are opposite, and the polarities of the voltages (i.e., the voltage polarity of the coupled data line) of any two second sub-pixels 1032 (e.g., the red sub-pixel or the green sub-pixel) adjacent to each other (i.e., closest by distance) are opposite.

In some implementations, polarities of voltages (i.e., the polarity of the voltage of the coupled data line) of any two third sub-pixels 1303 (e.g., the blue sub-pixel) adjacent to each other (i.e., closest by distance) are identical. In some implementations, the polarities of the voltages of the data lines coupled to any two third sub-pixels 1303 (e.g., the blue sub-pixel) adjacent to each other (i.e., closest by distance) are opposite. In some implementations, the polarities of the voltages of the data lines coupled to any two third sub-pixels 1303 (e.g., the blue sub-pixel) adjacent to each other (i.e., closest by distance) of a portion of the third sub-pixels 1303 are identical, and the polarities of the voltages of the data lines coupled to any two third sub-pixels 1303 (e.g., the blue sub-pixel) adjacent to each other (i.e., closest by distance) of the remaining third sub-pixels 1303 are opposite.

In some implementations, the polarities of the voltages of all the first sub-pixels 1301 in a same row of pixel regions are set to a cyclic arrangement of “+−+− (positive, negative, positive, negative)”, the polarities of the voltages of all the second sub-pixels 1302 in this same row of pixel regions are also set to the cyclic arrangement of “+−+− (positive, negative, positive, negative)”, and then the polarities of the voltages of the third sub-pixels 1303 in this same row of pixel regions can only be set to a cyclic arrangement of “++−− (positive, positive, negative, negative)”. Accordingly, the polarities of the voltages of the third sub-pixels 1303 in the row direction cannot be averaged. However, the polarities of the voltages of the first sub-pixels 1301 and the second sub-pixels 1302 in the pixel regions of a same row are averaged, thereby effectively improving the phenomenon of shake lines.

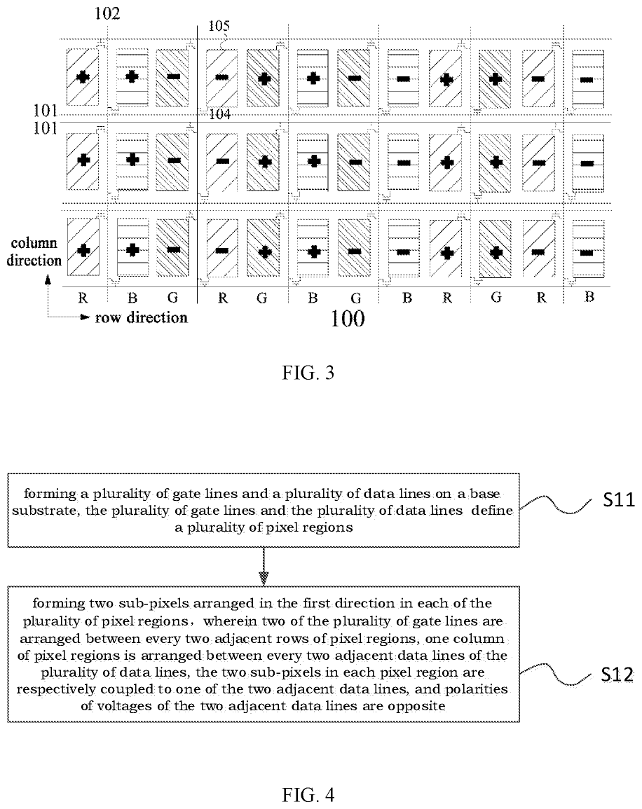

FIG. 3 is a schematic top view of an arrangement of a display substrate according to another embodiment of the present disclosure. As shown in FIG. 3, in some implementations, the first sub-pixel 1301 may be one of the red sub-pixel and the green sub-pixel, e.g., the red sub-pixel, the second sub-pixel 1302 may be the other of the red sub-pixel and the green sub-pixel, e.g., the green sub-pixel, and the third sub-pixel 1303 may be a blue sub-pixel. Since the human eye is more sensitive to light in the green band or red band than the light in the blue band, the polarities of the voltages of all red (R) sub-pixels in a same row of pixel regions are set to a cyclic arrangement of “+−+−”, the polarities of the voltages of all green (G) sub-pixels in this same row of pixel regions are set to a cyclic arrangement of “−+−+”, while the polarities of the voltages of all blue (B) sub-pixels in this same row of pixel regions can only be set to a cyclic arrangement of “++−−”, so that the polarities of the voltages of the red sub-pixels and the green sub-pixels in the row direction can be averaged, and when an observer watches, no obvious streakiness phenomenon will be observed even if a few frames of images are missed due to shaking his head.

According to embodiments of the present disclosure, those skilled in the art can design correspondingly the types of the sub-pixels according to the actual display effect of the display substrate. Specifically, the sub-pixels may include, for example, the red sub-pixel, the green sub-pixel, the blue sub-pixel, or the red sub-pixel, the green sub-pixel, the blue sub-pixel, a white sub-pixel, etc. In some implementations of the present disclosure, the sub-pixels may only include the red sub-pixel, the green sub-pixel, and the blue sub-pixel. As a result, the display panel can realize color display while simplifying a display control system.

In some implementations, the sub-pixels in a same row of pixel regions may be periodically arranged in a sequence of the red sub-pixel, the blue sub-pixel, the green sub-pixel, the red sub-pixel, the green sub-pixel, the blue sub-pixel, the green sub-pixel, the blue sub-pixel, the red sub-pixel, the green sub-pixel, the red sub-pixel and the blue sub-pixel. That is, the sub-pixels in a same row of pixel regions are cyclically arranged with RBGRGBGBRGRB as a minimum repetition period. This can realize that the polarities of the voltages of any two adjacent red sub-pixels in a same row of pixel regions are opposite, and the polarities of the voltages of any two adjacent green sub-pixels in a same row of pixel regions are opposite, which can effectively reduce a risk of shake lines in the dual gate structure.

In some implementations, the sub-pixels in the a row of pixel regions may be periodically arranged in a sequence of the green sub-pixel, the blue sub-pixel, the red sub-pixel, the green sub-pixel, the red sub-pixel, the blue sub-pixel, the red sub-pixel, the blue sub-pixel, the green sub-pixel, the red sub-pixel, the green sub-pixel and the blue sub-pixel. That is, the sub-pixels in a same row of pixel regions are cyclically arranged with GBRGRBRBGRGB as a minimum repetition period. This can also realize that the polarities of the voltages of any two adjacent green sub-pixels in a same row of pixel region are opposite, and any two adjacent red sub-pixels in a same row of pixel regions are opposite, which can effectively reduce the risk of shake lines in the dual gate structure.

In some implementations, the sub-pixels located in a same column can emit light of a same color, and thus the sub-pixels with the same polarity of the voltage are arranged in the column direction, which facilitates simplification of an electrical control method and display method of each sub-pixel, thereby narrowing the bezel of the display panel including the display substrate described herein.

In some implementations, as shown in FIG. 3, a pixel electrode 105 in each sub-pixel may be coupled to a drain of a thin film transistor (TFT) 104, and a gate and a source of the thin film transistor (TFT) 104 may be respectively coupled to a corresponding gate line 101 and a corresponding data line 102, so as to control the light emission of the sub-pixels. In addition, in the display substrate based on the dual gate structure, two sub-pixels of the sub-pixels located in a same row coupled to a same data line 102 have a same polarity of the voltage, wherein the thin film transistor 104 of one sub-pixel may be arranged at an upper right corner of the pixel electrode 105 and coupled to the gate line 101 above the pixel electrode 105, and the thin film transistor 104 of the other sub-pixel may be arranged at a lower left corner of the pixel electrode 105 and coupled to another gate line 101 below the pixel electrode 105. In addition, in each of the sub-pixels located in a same column, the thin film transistor 104 is arranged at a same position and is arranged at the upper right corner of the pixel electrode 105 or at the lower left corner of the pixel electrode 105.

In sum, according to the display substrate provided by the present disclosure, the polarities of the voltages of any two adjacent first sub-pixels in the pixel regions located in a same row are opposite, and the polarities of the voltages of any two adjacent second sub-pixels in the pixel regions located in a same row are opposite, and thus the problem of difference in pixel brightness due to the difference in the positive and negative voltages of the two adjacent data lines of the dual gate structure can be effectively solved spatially, thereby effectively alleviating the problem of shake lines of the dual gate structure.

In another aspect, the present disclosure provides a method of manufacturing a display substrate. In some implementations, the method includes: forming a plurality of gate lines in parallel with each other in a first direction on a base substrate; forming a plurality of gate lines in parallel each with other in a second direction on the base substrate, wherein the first direction and the second direction intersect each other, the plurality of gate lines and the plurality of data lines are formed to define a plurality of pixel regions, the plurality of pixel regions are arranged in a form of a matrix with multiple rows in the first direction and multiple columns in the second direction, and forming two sub-pixels arranged in the first direction in each of the plurality of pixel regions, where two of the plurality of gate lines are arranged between two adjacent rows of pixel regions of the plurality of pixel regions, a column of pixel regions of the plurality of pixel regions is arranged between two adjacent data lines of the plurality of data lines, the two sub-pixels in each pixel region are respectively coupled to one of the two adjacent data lines, and polarities of voltages of the two adjacent data lines are opposite, where the two sub-pixels in each pixel region are two of a first sub-pixel, a second sub-pixel and a third sub-pixel, and where in the pixel regions located in a same row, the polarities of the voltages of the data lines to which any two closest first sub-pixels are coupled are opposite, and the polarities of the voltages of the data lines to which any two closet second sub-pixels are coupled are opposite.

FIG. 4 is a flowchart of a method of manufacturing a display substrate according to an embodiment of the present disclosure. Referring to FIG. 4 in combination with FIGS. 2 and 3, in some implementations, the method includes steps S11 and S12.

In step S11, a plurality of gate lines 101 in parallel with each other in a row direction (i.e., a first direction) and a plurality of data lines 102 in parallel with each other in a column direction (i.e., a second direction) are formed on a base substrate (not shown).

In some implementations, the plurality of gate lines 101 and the plurality of data lines 102 are formed to define a plurality of pixel regions, and the plurality of pixel regions are arranged in a form of a matrix with multiple rows in the first direction and multiple columns in the second direction.

In step S12, two sub-pixels arranged in the first direction are formed in each pixel region of the plurality of pixel regions, where two of the plurality of gate lines 101 are arranged between two adjacent rows of pixel regions, a column of pixel regions is arranged between two adjacent data lines 102, the two sub-pixels in each pixel region are respectively coupled to one of the two adjacent data lines 102, and the polarities of the voltages of the two adjacent data lines 102 are opposite.

In some implementations, existing processes such as a patterning process may be used to form the two sub-pixels arranged in the first direction in each pixel region. two of the plurality of gate lines are arranged between two adjacent rows of pixel regions of the plurality of pixel regions, two sub-pixels in each pixel region are respectively coupled to one of the two adjacent data lines 102, and the polarities of the voltages of the two adjacent data lines 102 are opposite.

In some implementations, the two sub-pixels in each pixel region are two of a first sub-pixel (e.g., a green sub-pixel), a second sub-pixel (e.g., a red sub-pixel) and a third sub-pixel (e.g., a blue sub-pixel). In the pixel regions of a same row, the polarities of the voltages of the data lines 102 coupled to any two closest first sub-pixels are opposite, and the polarities of the voltages of the data lines 102 coupled to any two closest second sub-pixels in the pixel regions of a same row are opposite.

In some implementations, the first sub-pixel is one of the red sub-pixel and the green sub-pixel, the second sub-pixel is the other of the red sub-pixel and the green sub-pixel, and the third sub-pixel is the blue sub-pixel.

According to the display substrate manufactured by the method of the present disclosure, the polarities of the voltages of any two adjacent first sub-pixels in the pixel regions located in a same row are opposite, and the polarities of the voltages of any two adjacent second sub-pixels in the pixel regions located in a same row are opposite, and thus the problem of difference in pixel brightness due to the difference in the positive and negative voltages of the two adjacent data lines of the dual gate structure can be effectively solved spatially, thereby effectively alleviating the problem of shake lines of the dual gate structure.

In another aspect, the present disclosure provides a display panel. In some implementations, the display panel includes the display substrate 100 described herein or manufactured according to the method described herein and an opposite substrate 200, where the opposite substrate 200 and the display substrate 100 are aligned and assembled to form a cell. In some implementations, the display substrate 100 may be an array substrate, and the opposite substrate 200 may be a color filter substrate.

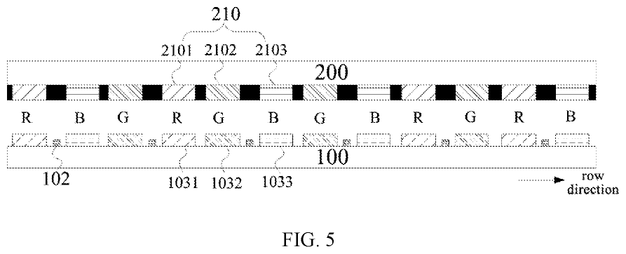

FIG. 5 is a schematic cross-sectional diagram of a structure of a display panel according to an embodiment of the present disclosure. As shown in FIG. 5, in some implementations, the color filter substrate 200 has color resist regions (CF) 210 arranged in a one-to-one correspondence with a plurality of sub-pixels on the display substrate 100. That is, when the sub-pixels in a same row on the display substrate 100 are cyclically arranged in a sequence of a red sub-pixel, a blue sub-pixel, a green sub-pixel, a red sub-pixel, a green sub-pixel, a blue sub-pixel, a green sub-pixel, a blue sub-pixel, a red sub-pixel, a green sub-pixel, a red sub-pixel and a blue sub-pixel, the plurality of color resist regions located in a same row on the color filter substrate 200 are correspondingly cyclically arranged in a sequence of a red color resist region, a blue color resist region, a green color resist region, a red color resist region, a green color resist region, a blue color resist region, a green color resist region, a blue color resist region, a red color resist region, a green color resist region, a red color resist region and a blue color resist region, so as to fully reduce the risk of shake lines of the display panel during the display process.

In sum, according to the display panel provided by the present disclosure, the risk of shake lines of the dual gate structure of the display panel is reduced, and thus the display effect of the display panel is effectively improved. It should be understood by those skilled in the art that the features and advantages described above for the display substrate are still applicable to the display panel, and will not be repeated herein.

In another aspect, the present disclosure provides a display device including the display panel described herein.

The type of the display device according to the present disclosure is not particularly limited, and suitable display devices include, but not limited to, any products or components with display functions such as display screens, TVs, mobile phones, laptop computers or smart watches. Those skilled in the art can make a corresponding selection based on the actual use requirements of the display device, which will not be repeated herein. It should be noted that the display device includes necessary components and structures other than the display panel. Taking the display screen as an example, other necessary components and structures may include, for example, a housing, a control circuit board or power cords, etc. Those skilled in the art can make corresponding supplements according to the functions of the display device, which will not be repeated herein.

In sum, according to the display device provided by the present disclosure, the display panel of the display device achieves a narrower lower frame and a lower risk of shake lines, thereby effectively improving the customer experience of the display device. It should be understood by those skilled in the art that the features and advantages described above for the display panel are still applicable to the display device, and will not be repeated herein.

In the description of this specification, it should be understood that terms “first”, “second”, “third” and the like are only used for descriptive purposes, and should not be understood as indicating or implying relative importance of technical features indicated or implicitly indicating the number of the technical features indicated. Therefore, the feature defined by “first”, “second”, “third” and the like may explicitly or implicitly include at least one such feature. In the description of this specification, words “a plurality of” means including at least two, such as two, three, etc., unless otherwise specifically defined.

In the description of this specification, phrases “one embodiment”, “some implementations”, “an example”, “specific examples”, “some examples” and the like means that features, structures, materials or characteristics described in conjunction with an embodiment or example are included in at least one embodiment or example of the present disclosure. In this specification, the schematic representations of the above-mentioned terms, words or phrases do not necessarily refer to the same embodiment or example. Moreover, the described specific features, structures, materials or characteristics may be combined in any one or more embodiments or examples in a suitable manner. In addition, those skilled in the art can combine the different embodiments or examples and the characteristics of the different embodiments or examples described in this specification without contradicting each other.

While the embodiments of the present disclosure have been shown and described above, it should be understood that the above embodiments are only for the purpose of illustrating the principles of the present disclosure, but the disclosure is not limited thereto. Various changes, modifications, substitutions and improvements can be made by those skilled in the art without departing from the spirit and scope of the disclosure, and those changes, modifications, substitutions and improvements are also considered to be within the scope of the disclosure.

1. A display substrate comprising: a plurality of gate lines in parallel with each other in a first direction and a plurality of data lines in parallel with each other in a second direction, the first direction and the second direction intersect each other, wherein
a plurality of pixel regions are defined by the plurality of gate lines and the plurality of data lines, and arranged in a form of a matrix with multiple rows in the first direction and multiple columns in the second direction, each of the plurality of pixel regions has two sub-pixels arranged in the first direction,
two of the plurality of gate lines are arranged between every two adjacent rows of the plurality of pixel regions,
one column of pixel regions is arranged between every two adjacent data lines of the plurality of data lines, the two sub-pixels in each pixel region are respectively coupled to one of the two adjacent data lines, and polarities of voltages of the two adjacent data lines are opposite,
the two sub-pixels in each pixel region are two of a first sub-pixel, a second sub-pixel and a third sub-pixel, and
in the pixel regions located in a same row, the polarities of the voltages of the data lines to which any two closest first sub-pixels are coupled are opposite, and the polarities of the voltages of the data lines to which any two closet second sub-pixels are coupled are opposite.

2. The display substrate of claim 1, wherein in the pixel regions located in a same row, the polarities of the voltages of the data lines to which any two closest third sub-pixels of a portion of the third sub-pixels are coupled are identical, and the polarities of the voltages of the data lines to which any closest third sub-pixels of the remaining third sub-pixels are coupled are opposite.

3. The display substrate of claim 1, wherein in the pixel regions located in a same row, the polarities of the voltages of the data lines to which any two closest third sub-pixels of the third sub-pixels are coupled are identical.

4. The display substrate of claim 1, wherein in the pixel regions located in a same row, the polarities of the voltages of the data lines to which any two closest third sub-pixels of the third sub-pixels are coupled are opposite.

5. The display substrate of claim 2, wherein the sub-pixels comprises a red sub-pixel, a green sub-pixel and a blue sub-pixel.

6. The display substrate of claim 5, wherein the first sub-pixel is one of the red sub-pixel and the green sub-pixel, the second sub-pixel is the other of the red sub-pixel and the green sub-pixel, and the third sub-pixel is the blue sub-pixel.

7. The display substrate of claim 6, wherein in the pixel regions located in a same row, the sub-pixels are periodically arranged in a sequence of the red sub-pixel, the blue sub-pixel, the green sub-pixel, the red sub-pixel, the green sub-pixel, the blue sub-pixel, the green sub-pixel, the blue sub-pixel, the red sub-pixel, the green sub-pixel, the red sub-pixel and the blue sub-pixel.

8. The display substrate of claim 6, wherein in the pixel regions located in a same row, the sub-pixels are periodically arranged in a sequence of the green sub-pixel, the blue sub-pixel, the red sub-pixel, the green sub-pixel, the red sub-pixel, the blue sub-pixel, the red sub-pixel, the blue sub-pixel, the green sub-pixel, the red sub-pixel, the green sub-pixel and the blue sub-pixel.

9. The display substrate of claim 7, wherein the sub-pixels located in a same column are sub-pixels of a same color.

10. A method of manufacturing the display substrate of claim 1, comprising:
forming a plurality of gate lines in parallel with each other in a first direction on a base substrate;
forming a plurality of data lines in parallel with each other in a second direction on the base substrate, wherein the first direction and the second direction intersect each other, the plurality of gate lines and the plurality of data lines are formed to define a plurality of pixel regions, the plurality of pixel regions are arranged in a form of a matrix with multiple rows in the first direction and multiple columns in the second direction, and
forming two sub-pixels arranged in the first direction in each of the plurality of pixel regions,
wherein two of the plurality of gate lines are arranged between every two adjacent rows of pixel regions, one column of pixel regions is arranged between every two adjacent data lines of the plurality of data lines, the two sub-pixels in each pixel region are respectively coupled to one of the two adjacent data lines, and polarities of voltages of the two adjacent data lines are opposite,
the two sub-pixels in each pixel region are two of a first sub-pixel, a second sub-pixel and a third sub-pixel, and
in the pixel regions located in a same row, the polarities of the voltages of the data lines to which any two closest first sub-pixels are coupled are opposite, and the polarities of the voltages of the data lines to which any two closet second sub-pixels are coupled are opposite.

11. The method of claim 10, wherein the first sub-pixel is one of a red sub-pixel and a green sub-pixel, the second sub-pixel is the other of the red sub-pixel and the green sub-pixel, and the third sub-pixel is a blue sub-pixel.

12. A display panel, comprising:
the display substrate of claim 1; and
an opposite substrate aligned and assembled with the display substrate to form a cell.

13. The display panel of claim 12, wherein the display substrate is an array substrate, and the opposite substrate is a color filter substrate.

14. The display panel of claim 13, wherein the color filter substrate comprises a plurality of color resist regions, and the plurality of color resist regions are arranged in a one-to-one correspondence with the plurality of sub-pixels of the display substrate.

15. A display device, comprising the display panel of claim 12.

16. The display substrate of claim 3, wherein the sub-pixels comprises a red sub-pixel, a green sub-pixel and a blue sub-pixel.

17. The display substrate of claim 16, wherein the first sub-pixel is one of the red sub-pixel and the green sub-pixel, the second sub-pixel is the other of the red sub-pixel and the green sub-pixel, and the third sub-pixel is the blue sub-pixel.

18. The display substrate of claim 17, wherein in the pixel regions located in a same row, the sub-pixels are periodically arranged in a sequence of the red sub-pixel, the blue sub-pixel, the green sub-pixel, the red sub-pixel, the green sub-pixel, the blue sub-pixel, the green sub-pixel, the blue sub-pixel, the red sub-pixel, the green sub-pixel, the red sub-pixel and the blue sub-pixel.

19. The display substrate of claim 17, wherein in the pixel regions located in a same row, the sub-pixels are periodically arranged in a sequence of the green sub-pixel, the blue sub-pixel, the red sub-pixel, the green sub-pixel, the red sub-pixel, the blue sub-pixel, the red sub-pixel, the blue sub-pixel, the green sub-pixel, the red sub-pixel, the green sub-pixel and the blue sub-pixel.

20. The display substrate of claim 8, wherein the sub-pixels located in a same column are sub-pixels of a same color.
